(19) United States
(12) Patent Application Publication
(10) Pub. No.: US 2022/0202176 A1
(43) Pub. Date: Jun. 30, 2022

(54) CONCRETE BROOM CLEANER

(71) Applicants: John Nae'ole, Ka'a'awa, HI (US); Signe Nae'ole, Ka'a'awa, HI (US)

(72) Inventors: John Nae'ole, Ka'a'awa, HI (US); Signe Nae'ole, Ka'a'awa, HI (US)

(21) Appl. No.: 17/646,633

(22) Filed: Dec. 30, 2021

Related U.S. Application Data
(60) Provisional application No. 63/132,536, filed on Dec. 31, 2020.

(51) Int. Cl. A46B 17/06; B08B 1/00; B08B 3/08

(52) U.S. Cl. CPC A46B 17/06; A46B 2200/302; B08B 3/08; B08B 1/005

(57) ABSTRACT

A concrete broom cleaner that may feature a rectangular body that may hold a cleaning solution, an agitator that may have holes, a cover, and legs. The concrete broom may be inserted into the broom cleaner so that the bristles extend through the holes in the agitator, and the bristles may reach the cleaning solution in the body. The broom may be moved back and forth through the agitator which may allow the wet concrete to be scraped and washed off the broom bristles.

### CROSS-REFERENCE TO RELATED APPLICATIONS

This application is a Non-provisional Patent Application which claims the benefit of U.S. Provisional Patent Application No. 63/132,536, filed Dec. 31, 2020, the contents of which application are herein incorporated by reference in their entirety.

### FIELD OF THE DISCLOSURE

The present disclosure generally relates to concrete placement, and more particularly to a device operable to clean concrete brooms.

### BACKGROUND

Concrete is a very common material that is used for many purposes. In the laying and preparing of concrete, brooms may be used to texturize concrete rather than leaving a smooth surface. These brooms need to be cleaned frequently as the wet concrete sticks to the bristles of the brooms. Currently hoses and running water are used to clean these brooms so that the brooms may continue to be used. Using running water to clean the brooms uses a lot of water and is not very efficient.

SUMMARY

Embodiments of the present disclosure may provide a concrete broom cleaner that may comprise a rectangular body, an agitator, and a cover. The rectangular body may have four sides, a bottom, and may have a ledge around a top portion of the four sides that may form the rectangular body. The agitator may have a plurality of holes. The agitator can be positioned inside the body, such that there is space between the agitator and the bottom of the body. The cover may be configured to fit over the ledge of the body and the agitator. The cover may have an open portion allowing access to the agitator, and a guard that extends downwards towards the agitator.

Other embodiments of the disclosure can provide a method for using a concrete broom cleaner. The method can comprise inserting an agitator into a cavity of a body of a concrete broom cleaner; placing a cover over the agitator and body; filing the body with a cleaning solution, wherein the cleaning solution can rise above the agitator; inserting a concrete broom head into the cavity of the body until the bristles on the concrete broom head can engage with the agitator; and moving the bristles of the concrete broom head across the agitator.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 depicts top view of a concrete broom cleaner according to an embodiment of the disclosure;

FIG. 2 depicts an exploded view of the concrete broom cleaner of FIG. 1 according to an embodiment of the disclosure;

FIG. 3A depicts perspective view of an agitator of the concrete broom cleaner of FIG. 1 according to an embodiment of the disclosure;

FIG. 3B depicts a perspective view of an embodiment of a concrete broom cleaner according to the disclosure;

FIG. 4 depicts a perspective view of a concrete broom cleaner with feet according to an embodiment of the disclosure;

FIG. 5 depicts an exploded view of the concrete broom cleaner of FIG. 4 according to an embodiment of the disclosure;

FIG. 6 depicts a cross-sectional view of the concrete broom cleaner of FIG. 4 according to an embodiment of the disclosure;

FIGS. 7A and 7B depict cross-sectional views of a concrete broom cleaner according to an embodiment of the disclosure;

FIG. 8A depicts an exploded view of a concrete broom cleaner according to an embodiment of the disclosure;

FIG. 8B depicts a cross-sectional view of a side of the concrete broom cleaner of FIG. 8A according to an embodiment of the disclosure;

FIG. 9A depicts perspective views of a concrete broom cleaner according to an embodiment of the present disclosure; and

FIG. 9B depicts a top view of a concrete broom cleaner according to an embodiment of the present disclosure.

### DETAILED DESCRIPTION

Embodiments of the present disclosure may generally provide a concrete broom cleaner that may be used to aid in the removal of wet concrete from a concrete broom. A concrete broom cleaner may include a body, an agitator, and a cover. The concrete broom cleaner may also include additional components including, but not limited to, a plurality of feet, at least one handle, and a carrying chain. The disclosure may also provide a method for using the concrete broom cleaner.

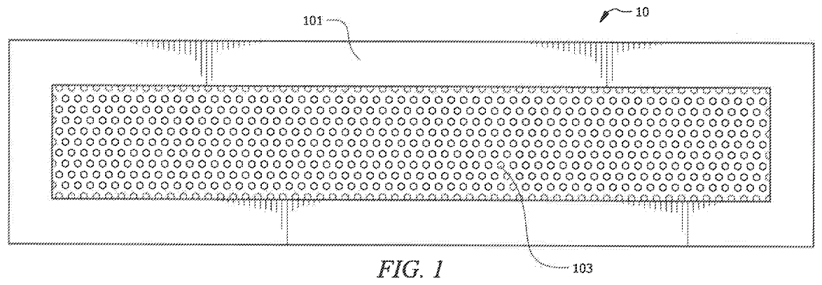

FIG. 1 depicts concrete broom cleaner 10 according to an embodiment of the present disclosure. Concrete broom cleaner 10 can have four sides connected in a rectangular shape with a bottom. Concrete broom cleaner 10 alternatively can have one or more sides and be formed into other shapes as might be needed. Concrete broom cleaner 10 may hold a cleaning solution and may feature agitator 103 to help remove concrete from bristles of a concrete broom. Concrete broom cleaner 10 and agitator 103 can have a length longer than the length of a concrete broom head to allow movement by the broom head through agitator 103. Agitator 103 may be designed so the bristles of the concrete broom may fit through the holes in agitator 103 and the concrete can be scraped off the bristles as the broom is moved back and forth. Agitator 103 may be shaped as an open rectangular box in an embodiment of the present disclosure. Cover 101 can fit over the sides 205 of the body 201 and may be designed to keep the cleaning solution and agitator 103 in concrete broom cleaner 10, even if some part of the concrete broom becomes stuck against an edge or under cover 101. Concrete broom cleaner 10 may be able to hold a substantial amount of the cleaning solution so that a broom may be cleaned multiple times before the cleaning solution is replaced. The cleaning solution can be one or more of water, soap, vinegar, bleach, laundry detergent, dish detergent, baking soda, or combinations thereof.

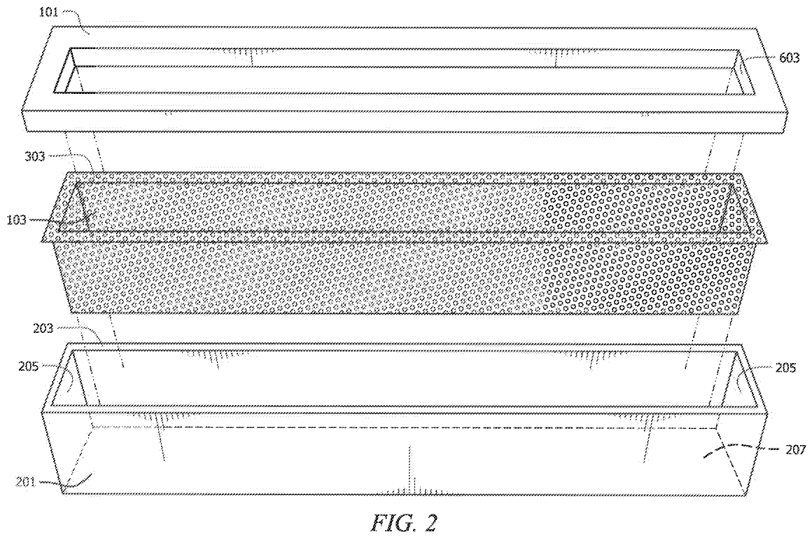

FIG. 2 depicts an exploded view of concrete broom cleaner 10 of FIG. 1 according to an embodiment of the present disclosure. This exploded view shows three components that may comprise concrete broom cleaner 10. From top to bottom of FIG. 2 is body 201, agitator 103, and cover 101. Body 201 may be made of materials including, but not limited to, stainless steel, aluminum, titanium, PVC, hard plastic, other durable materials, or combinations thereof. Body 201 may be shaped as an open rectangular box, having four sides 205 and a bottom 207, where opposing pairs of sides 205 have the same length and height. The four sides 205 and bottom 207 can create a cavity 209 in the body 201. Body 201 may be of a depth to allow a sufficient amount of the cleaning solution to be held and may be of a length longer than the length of a concrete broom head, to allow a concrete broom head to be moved back and forth within body 201. Body 201 may feature ledge 203 that can extend inward from a top portion of the sides 205.

Agitator 103 may be configured as a rectangular box with an open top, similar to what was described regarding body 201, and may also feature lip 303 that can engage with the ledge 203 of body 201. Agitator 103 may include a plurality of holes that may be sized large enough to allow the bristles of a concrete broom through and may be sized small enough to allow wet concrete to be scraped off the bristles. Agitator 103 may be sized to fit within body 201 but may still be longer than the head of the concrete broom while having room to move the broom head back and forth within agitator 103, allowing for the removal of concrete.

Cover 101 may be sized to fit over the sides of both agitator 103 and body 201. Cover 101 may keep agitator 103 and body 101 from lifting out when the concrete broom is being cleaned. Cover 101 may have edges that extend down into an opening of agitator 103 to form guard 603. Cover 101 may also be open in the center allowing a concrete broom through to touch or abut agitator 103.

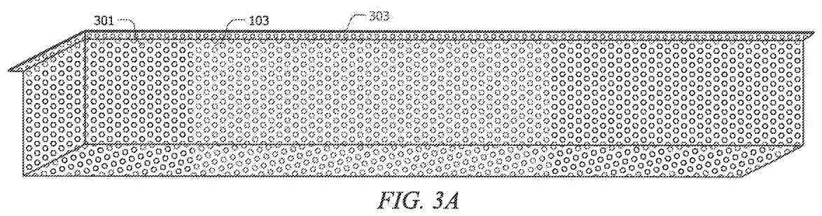

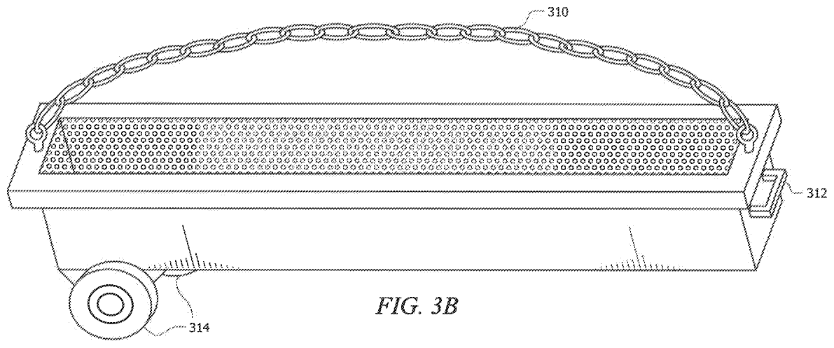

FIG. 3A depicts a close-up view of agitator 103 of concrete broom cleaner 10 of FIG. 1 according to an embodiment of the present disclosure. Agitator 103 may be made of a material including, but not limited to, stainless steel, aluminum, titanium, PVC, hard plastic, other durable materials, or combinations thereof. Agitator 103 may feature a plurality of holes 301. Holes 301 may be sized large enough to allow concrete broom bristles through but may also be sized small enough that the holes 301 are able to remove concrete when the broom head is moved back and forth along holes 301 of agitator 103. The plurality of holes 301 are depicted as circles, but other shapes can be used without departing from the present disclosure. FIG. 3A depicts the plurality of holes 301 being present on all surfaces of the agitator 103, other embodiments have just the bottom side of the agitator 103 with holes 301. Still other embodiments can have variable number of surfaces of the agitator 103 with a plurality of holes 301, while others are solid, or feature other openings to still allow the cleaning solution to flow through the agitator 103. Agitator 103 can have a lip 303 extending outwardly from a top portion of agitator 103 than can engage with the ledge 203 of body 201 as to hold the agitator 103 above the bottom 207 of the body 201. The lip 303 holding the agitator 103 above the bottom 207 of the body 201 allows the bristles of the concrete broom to be suspended in the cleaning solution without touching another surface. This can allow the bristles to be scraped and cleaned off without losing shape or wearing out from being pushed up against the bottom 207 of the body 201 while being scraped.

Embodiments of the concrete broom cleaner 10 depicted in FIG. 3B can have one or more transportation mechanisms to make moving to the site easier. The transportation mechanisms can include a chain 310 attached to two sides of the body 201, at least one handle 312 attached to one side of the body 201, one or more pairs of wheels 314 attached to the bottom 207 of the body 201, or combinations thereof. Other transportation mechanisms can be attached to the body 201.

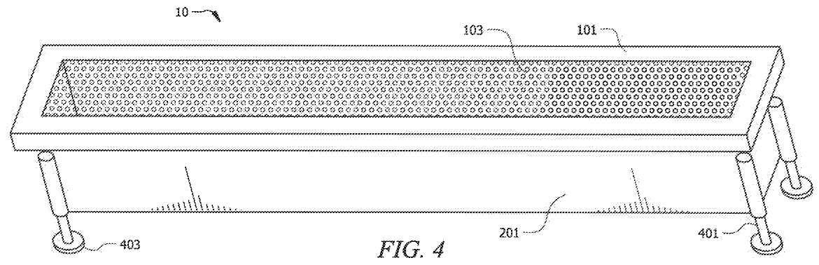

FIG. 4 depicts concrete broom cleaner 10 with feet according to an embodiment of the present disclosure. Concrete broom cleaner 10 may be made up of body 201, agitator 103, and cover 101 as described above. The embodiment of concrete broom cleaner 10 depicted in FIG. 4 can also have a plurality of legs 401. The plurality of legs 401 can be attached to the sides of the body 201 or the corners where two of the sides meet.

In FIG. 4, four adjustable legs 401 can be attached to each of the four corners of the rectangular body 201. The plurality of legs 401 may be adjustable so that the plurality of legs 401 may raise or lower the level of broom cleaner 10 so the broom cleaner 10 may be at an optimal height for the user. Each of the plurality of legs 401 can be adjusted to a different height to create a level surface even if the environment the concrete broom cleaner 10 is placed on is not level. Each of the plurality of legs 401 can have a foot 403 attached to the bottom. The foot 403 can provide a wider, more stable surface for the concrete broom cleaner 10 to rest upon. FIG. 4 depicts the feet 403 as long bars. Other embodiments of the concrete broom cleaner 10 can used different shapes for the foot 403 such as claws, disks, or combinations thereof.

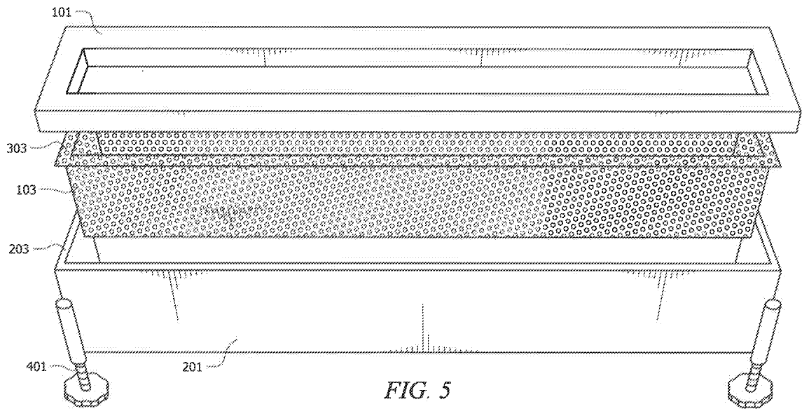

FIG. 5 depicts an exploded view of concrete broom cleaner 10 of FIG. 4 according to an embodiment of the present disclosure. Body 201 may form the bottom portion of concrete broom cleaner 10 and may be supported by four legs 401. It should be appreciated that the four legs 401 may be adjustable in embodiments of the present disclosure. Body 201 may receive agitator 103. Agitator 103 may feature lip 303 that engages with the ledge 203 of body 201 to position agitator 103 relative to body 201 so that there may be room for the broom's bristles to go through agitator 103 and be washed in the cleaning solution that may fill body 201 without touching the bottom surface 207 of the body 201. Cover 101 may be placed on top of agitator 103 when the agitator 103 is in position within body 201. Cover 101 may keep agitator 103 in place even when a concrete broom is being cleaned. Cover 101 may also help keep the cleaning solution inside of body 201 from escaping when concrete broom cleaner 10 is in use. Cover 101 can extend down around the sides of the agitator 103 and of the body 201.

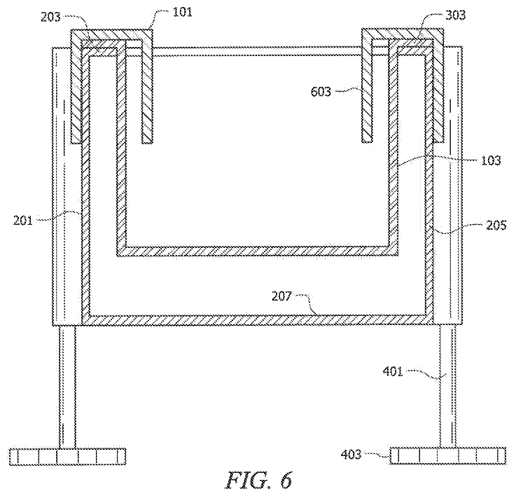

FIG. 6 depicts a cross-sectional view of concrete broom cleaner 10 of FIG. 4 according to an embodiment of the present disclosure. Concrete broom cleaner 10 may be held up by a plurality of legs 401. The plurality of legs 401 may be adjustable so the height may be changed to best suit the environment, the surface where concrete broom cleaner 10 is being used, and/or users' needs. The plurality of legs 401 may also each include a foot 403 that may help maintain the balance of concrete broom cleaner 10. Body 201 may hold the cleaning solution for cleaning the concrete brooms. Agitator 103 may have lip 303 that may sit on the ledge 203 of body 201. Lip 303 may support agitator 103 suspended above the bottom 207 of body 201 so that bristles on the concrete broom may extend below agitator 103 into the cleaning solution. The concrete broom may be moved back and forth along the agitator 103 within body 201 so that the bristles may run through agitator 103 and the cleaning solution filling body 201. The holes 301 in agitator 103 may be used to scrape the wet concrete from the bristles, and the cleaning solution in body 201 may wash the wet concrete off agitator 103. Cover 101 may be placed on top of agitator 103. Cover 101 may include guard 603 that may extend down into agitator 103. Guard 603 may keep the cleaning solution from splashing out of body 201 when the broom is being moved back and forth in the cleaning solution filling body 201. The broom head also may be scraped against guard 603 once cleaned to remove excess cleaning solution and keep all the cleaning solution in body 201.

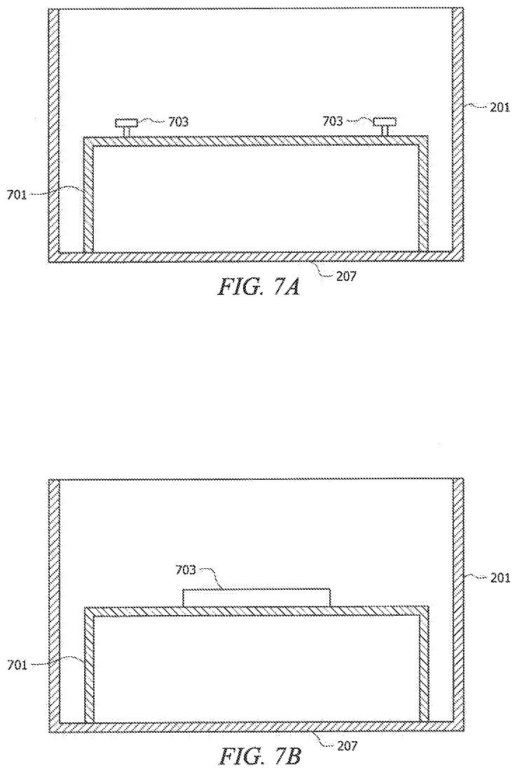

FIGS. 7A and 7B depict cross-sectional views of a concrete broom cleaner 10 according to an embodiment of the present disclosure. FIG. 7A depicts body 201 holding agitator 701. Agitator 701 may be shaped like a rectangular box with an open bottom. Agitator 701 may rest on a bottom surface 207 of body 201 with the open bottom of agitator 701 facing the bottom surface 207 of the body 201. A bottom portion of the sides of the agitator 701 can rest against the bottom 207 of the body 201. Body 201 may still be filled with the cleaning solution as described in other embodiments of the present disclosure. A top surface of agitator 701 may be below the level of the cleaning solution contained in body 201 so that the bristles of the concrete broom may be cleaned. A concrete broom head can be pressed into the agitator 701. When the concrete broom head is inserted, the bristles will be below the level of the cleaning solution without the bristles touching the bottom of the body 201. Agitator 701 may also feature at least two handles 703. The at least two handles 703 may be located at opposite ends of agitator 701 so that the agitator 701 may be removed from body 201 when the concrete broom cleaner 10 is not in use. The handles 703 can be attached to a top surface of the agitator 701. The concrete broom cleaner 10 may still be used in the same manner with the concrete broom bristles being run back and forth across the surface of agitator 701 to remove the wet concrete.

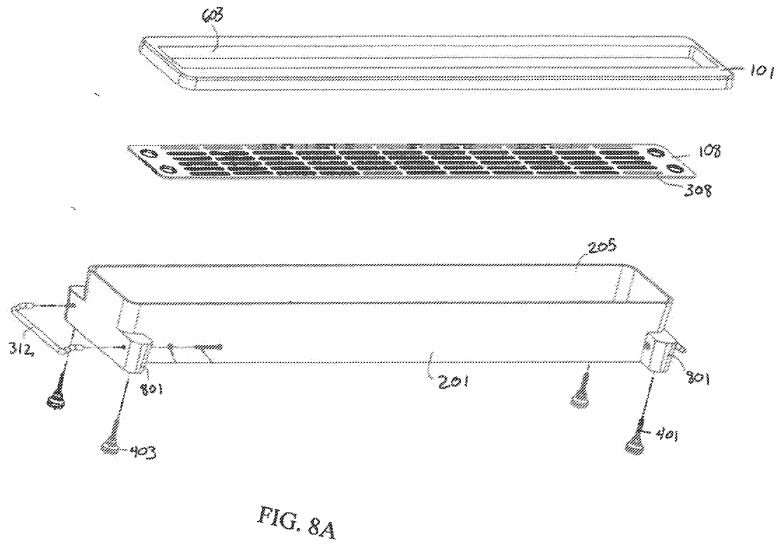

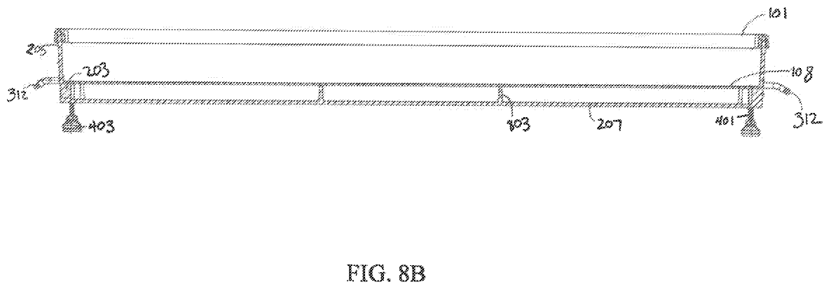

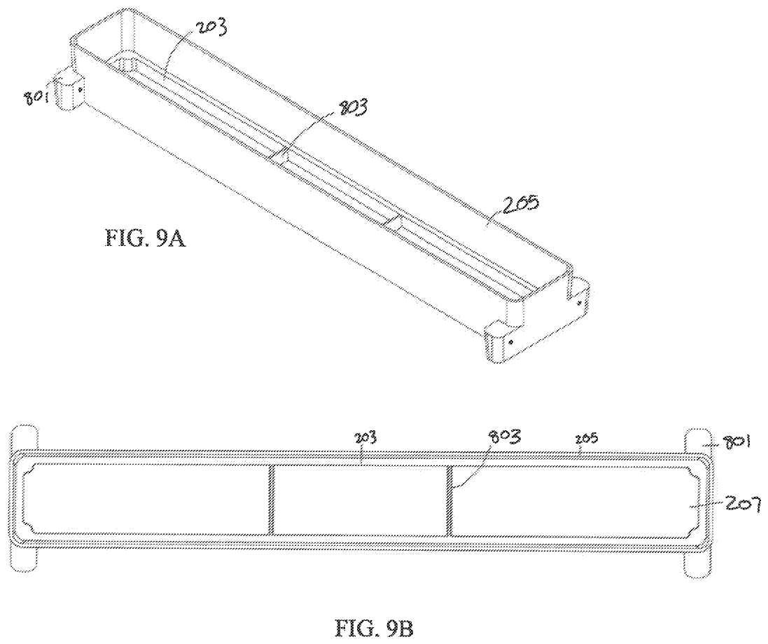

FIGS. 8A-9B can depict a different embodiment of a concrete broom cleaner according to the disclosure. The embodiment can still have a rectangular body 201 with four sides 205, a bottom 207, an agitator, and a cover 101 as described in other embodiments. The ledge 203 can extend from a bottom portion of the four sides 205 and also be connected to the bottom 207. The body 201 can also have one or more ribs 803 attached to the bottom 207 and can support the agitator 108. Agitator 108 can be shaped as a flat rectangular plate with a plurality of holes. The plurality of holes 308 can be oblong in shape. The plurality of holes 308 can accept larger groups of bristles from the broom head at a time to clean.

Body 201 can also have four hips 801 that extend from a bottom portion of two of the sides 205 of the body 201. Each of the hips 801 can accept one of the plurality of legs 401. The hips 801 can allow the legs 401 to be adjusted to a higher or lower level based on the need at the time. Each of the legs 401 can have a foot 403 attached to a bottom end. One or more handles can be attached to the sides 205 of the body. The handles can be longer than in other embodiments and may extend to attach to the hips 801.

Ledge 203 can extend from the bottom portion of the four sides 205 of the body 201. Body 201 can have one or more ribs 803 that extend from the ledge 203 on one of the sides 205 across the bottom 207 to the ledge 203 on the opposing side 205. The ribs 803 can be the same height from the bottom 207 as the ledge 203. The longer the body 201 is, the more ribs 803 can be placed. Ribs 803 can be spaced evenly across the bottom 207 of the body 201. The agitator 108 can be placed into the cavity of the body 201 until it rests upon the ledge 203 and ribs 803. The ledge 203 and ribs 803 can have a height above the bottom 207 of the body 201 such that there is enough room for the bristles of the concrete broom head to extend through the holes 308 of the agitator 108 and not contact the bottom 207 of the body 201. Cleaning solution can fill the body 201 above the level of the agitator 108.

The disclosure can also provide a method for using the concrete broom cleaner described above. The method can include inserting the agitator 103 into a cavity of the body 201 of the concrete broom cleaner 10. The agitator 103 should be positioned in the cavity of the body 201 so that there is space between the bottom of the body 201 and the agitator 103.

The method can further include placing a cover 101 over the agitator 103 and the body 201. The method can further include filing the body 201 with a cleaning solution. The body 201 can be filled with enough cleaning solution so the level of the cleaning solution rises above the agitator 103. The cleaning solution can be one or more of water, soap, vinegar, bleach, laundry detergent, dish detergent, baking soda, or combinations thereof. Certain embodiments of the method can include adjusting the height of the plurality of legs 401 attached to the body 201 to complete the set-up of the concrete broom cleaner 10.

The method can further include inserting a concrete broom head into the cavity of the body 201. The concrete broom head can be inserted until bristles on the concrete broom head are engaged with the agitator 103. The method can further include moving the bristles of the concrete broom head across the agitator 103. By moving the bristles across the agitator 103, wet concrete stuck in the bristles of the concrete broom head can be scraped off.

Certain embodiments of the method can include after moving the bristles, pressing the bristles against the guard 603 of the cover 101 to remove excess moisture from the bristles. For the concrete broom to be used further the broom cannot be too wet or carry the cleaning solution back to the poured, wet concrete. The guard 603 of the cover 101 can offer a way to help squeeze excess moisture from the bristles to help return the concrete broom to use quicker.

Other embodiments of the method can include transporting the concrete broom cleaner 10 to a site using a transportation mechanism attached to the body 201 of the concrete broom cleaner 10. The transportation mechanism can be one or more of a plurality of wheels 314, one or more handles 312, a strap, a chain 310, or combinations thereof. The transportation mechanism used can correspond to the location of the site and the environment the concrete broom cleaner 10 will need to be transported across to reach the site.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A concrete broom cleaner comprising:
a rectangular body having four sides, a bottom, and a ledge around a portion of the four sides, wherein the body is operable to hold a cleaning solution therein;
an agitator having a plurality of holes formed therein, the agitator positioned inside the body such that there is space between the agitator and the bottom of the body; and
a cover configured to fit over the ledge of the body and agitator, the cover having an open portion allowing access to the agitator and a guard that extends downward towards the agitator.

2. The concrete broom cleaner of claim 1, further comprising:
a plurality of legs, wherein each of the plurality of legs is attached to one of the four sides of the body.

3. The concrete broom cleaner of claim 2, wherein the plurality of legs are operable to be adjustable in height.

4. The concrete broom cleaner of claim 2, further comprising:
at least two wheels attached to a bottom of two of the plurality of legs.

5. The concrete broom cleaner of claim 4, further comprising:
one or more feet attached to the bottom of each of the plurality of legs that does not have a wheel attached, the one or more feet operable to stabilize the concrete broom cleaner.

6. The concrete broom cleaner of claim 2, further comprising:
a plurality of feet, wherein each of the plurality of legs has a foot of the plurality of feet attached to the bottom of the body.

7. The concrete broom cleaner of claim 1, further comprising:
at least two wheels attached to the bottom of the body.

8. The concrete broom cleaner of claim 1, further comprising:
one or more handles attached to the sides of the body

9. The concrete broom cleaner of claim 1, wherein the ledge extends inwardly from the portion of the sides of the body.

10. The concrete broom cleaner of claim 1, wherein the agitator has four sides, a bottom, and a lip that extends outwardly from a top portion of the four sides of the agitator, the lip operable to engage with the ledge of the body in order to suspend the agitator above the bottom of the body.

11. The concrete broom cleaner of claim 10, wherein the agitator only has holes in the bottom.

12. The concrete broom cleaner of claim 1, wherein the agitator has four sides and a top connected to a top portion of the four sides of the agitator, wherein a bottom portion of the four sides of the agitator rests on the bottom of the body.

13. The concrete broom cleaner of claim 12, wherein the agitator only has holes in the top of the agitator.

14. The concrete broom cleaner of claim 1, further comprising:
one or more ribs attached to the bottom of the body and extending from the ledge on a first side of the four sides of the body to the ledge on a second side of the four sides of the body, wherein the first side opposes the second side.

15. A method comprising:
inserting an agitator into a cavity of a body of a concrete broom cleaner;
placing a cover over the agitator and body;
filling the body with a cleaning solution, wherein the cleaning solution rises above the agitator;
inserting a concrete broom head into the cavity of the body until bristles on the concrete broom head are engaged with the agitator; and
moving the bristles of the concrete broom head across the agitator.

16. The method of claim 15, wherein the cleaning solution is one or more of water, soap, vinegar, bleach, laundry detergent, dish detergent, baking soda, or combinations thereof.

17. The method of claim 15, further comprising: after the step of moving the bristles, pressing the bristles against a guard of the cover to remove excess moisture from the bristles.

18. The method of claim 15, further comprising:
adjusting the height of a plurality of legs attached to the body.

19. The method of claim 15, further comprising:
transporting the concrete broom cleaner to a site using a transportation mechanism attached to the body of the concrete broom cleaner.

20. The method of claim 19, wherein the transportation mechanism is one or more of a plurality of wheels, one or more handles, a strap, a chain, or combinations thereof.
